(19) United States
(12) Patent Application Publication
(10) Pub. No.: US 2024/0209177 A1
(43) Pub. Date: Jun. 27, 2024

(54) METHOD OF DESULFURIZING SULFUR-CROSSLINKED RUBBER

(71) Applicants: TOYODA GOSEI CO., LTD., Kiyosu-shi (JP); NATIONAL UNIVERSITY CORPORATION TOKAI NATIONAL HIGHER EDUCATION AND RESEARCH SYSTEM, Nagoya-shi (JP)

(72) Inventors: Yuki OKABE, Kiyosu-shi (JP); Akishige SEO, Kiyosu-shi (JP); Aya IKEDA, Kiyosu-shi (JP); Toshiaki MURAI, Gifu-shi (JP)

(21) Appl. No.: 18/510,774

(22) Filed: Nov. 16, 2023

(30) Foreign Application Priority Data
Dec. 8, 2022 (JP) 2022-196275

(51) Int. Cl. C08J 11/28

(52) U.S. Cl. CPC C08J 11/28; C08J 2323/32

(57) ABSTRACT

A method of desulfurizing sulfur-crosslinked rubber includes adding a radical precursor that generates a radical active species that acts on a sulfur bond in the sulfur-crosslinked rubber and cleaves the sulfur bond and a radical initiator for generating a radical for converting the radical precursor into the radical active species to the sulfur-crosslinked rubber and performing heating.

### TECHNICAL FIELD

The present invention relates to a method of desulfurizing sulfur-crosslinked rubber.

### BACKGROUND ART

As a method of desulfurizing sulfur-crosslinked rubber (particularly, a method of desulfurizing used sulfur-crosslinked rubber to make it reusable recycled desulfurized rubber), currently, a method of performing physical desulfurizing when sulfur-crosslinked rubber is melted and kneaded to form a highly sheared flow field (shear desulfurization) is general.

Patent Literature 1 describes a method in which sulfur-crosslinked rubber containing carbon black is pulverized, put into a twin screw extruder, and desulfurized by applying a shear stress of 10 kg/cm² to 150 kg/cm² while heating to a temperature of 180° C. to 350° C., and recycled desulfurized rubber with cleaved sulfur-crosslinked bonds is produced. In addition, it also describes that a desulfurizing agent is used in combination therewith for shear desulfurization.

However, the problem with shear desulfurization is deterioration in physical properties (low selectivity) due to cleavage of the rubber main chain (other than S—S, and C—S bonds), and it is currently difficult to return recycled desulfurized rubber to the same state as new raw rubber. In addition, desulfurization occurs under high temperature conditions.

On the other hand, in the method in which a sulfur bond in the structure of sulfur-crosslinked rubber is chemically cleaved using a desulfurizing agent (regenerating agent) for desulfurization (chemical desulfurization), since the sulfur bond is selectively cleaved, cleavage of the main chain is less likely to occur. Therefore, the same molecular weight as that of new raw rubber can be maintained for recycled desulfurized rubber produced by chemical desulfurization, for which deterioration of physical properties can be reduced. In addition, desulfurization can be performed under mild conditions.

Examples of desulfurizing agents include disulfide compounds (R—S—S—R), thiol compounds (R—SH), dimethyl sulfoxide (DMSO), and amine compounds (NR₃). The desulfurizing agents described in Patent Literature 1 include diaryl disulfide, dihexyl disulfide, and thiophenol-iron oxide. In addition, the desulfurizing agent described in Patent Literature 2 includes phenyl-hydrazine-iron chloride, triphenylphosphine, thiols, and disulfides. In addition, the desulfurizing agent described in Patent Literature 3 includes amine compounds (octylamine, hexadecylamine, dioctylamine, trioctylamine, benzylamine, or 4-piperidinopiperidine).

However, since all of these desulfurizing agents are a group of compounds that emit a unique odor, the odor generated during desulfurization causes a physical burden on operators, and the recycled rubber after desulfurization also has an odor, which makes it difficult to use as a recycled material.

### CITATION LIST

### Patent Literature

[Patent Literature 1] Japanese Unexamined Patent Application Publication No. H9-227724 (JP H9-227724 A)
[Patent Literature 2] Japanese Unexamined Patent Application Publication (Translation of PCT Application) No. 2010-535912 (JP 2010-535912 A)
[Patent Literature 3] Japanese Unexamined Patent Application Publication (Translation of PCT Application) No. 2003-510437 (JP 2003-510437 A)

### SUMMARY OF THE INVENTION

### Technical Problem

Therefore, an object of the present invention is to desulfurize sulfur-crosslinked rubber while reducing deterioration in physical properties and reducing an odor during desulfurization and after desulfurization.

### Solution to Problem

[1] A method of desulfurizing sulfur-crosslinked rubber includes adding a radical precursor that generates a radical active species that acts on a sulfur bond in the sulfur-crosslinked rubber and cleaves the sulfur bond and a radical initiator for generating a radical for converting the radical precursor into the radical active species (that is, driving a radical reaction) to the sulfur-crosslinked rubber and performing heating.

[2] In [1], preferably, the radical precursor is at least one selected from the group consisting of phosphorus compounds, germanium, tin, arsenic, antimony, selenium, tellurium compounds, silicon compounds, and boron compounds. This is because these compounds have an affinity with sulfur atoms, generate almost no or little odor, and are readily available.

[3] In [1] or [2], preferably, the radical initiator is at least one selected from the group consisting of azo compounds and peracid compounds. This is because these compounds generate almost no or little odor, and are readily available.

### Operation

The mechanism of the desulfurization reaction in the present invention is inferred as follows.
1) Radicals are generated from a radical initiator by heating.
2) The generated radicals react with a radical precursor, and the radical precursor generates a radical active species.
3) The radical active species reacts with a sulfur bond in sulfur-crosslinked rubber to generate a radical intermediate.
4) The radical active species generated in 2) and the radical intermediate in 3) further react to cleave the sulfur bond.
5) Desulfurization of the sulfur-crosslinked rubber progresses while repeating 1)-4).

Since the radical active species generated from the radical precursor selectively reacts with a sulfur bond in the rubber and cleaves the sulfur bond, even when desulfurization progresses, cleavage of the main chain of the rubber is less likely to occur, and it is possible to reduce deterioration in physical properties.

The radical precursor and the radical initiator generate almost no or little odor compared to the desulfurizing agents listed in the section of the background art and thus an odor generated during desulfurization is reduced and an odor is less likely to remain in the rubber after desulfurization.

### Advantageous Effects of Invention

According to the present invention, it is possible to desulfurize sulfur-crosslinked rubber while reducing deterioration in physical properties and reducing an odor during desulfurization and after desulfurization.

### DESCRIPTION OF EMBODIMENTS

### <1> Sulfur-Crosslinked Rubber

The rubber types of sulfur-crosslinked rubber are not particularly limited, and examples thereof include ethylene propylene rubber (EPDM, EPM), natural rubber (NR), isoprene rubber (IR), butyl rubber (IIR), butadiene rubber (BR), styrene butadiene rubber (SBR), chloroprene rubber (CR), and nitrile rubber (NBR).

The sulfur-crosslinked rubber is preferably a pulverized product in the form of flakes, granules or the like that has been pulverized before desulfurization.

As the sulfur-crosslinked rubber, used rubber can be suitably used, and the usage time and usage conditions are not particularly limited. According to the present invention, used sulfur-crosslinked rubber can be desulfurized into recycled desulfurized rubber that can be reused.

### <2> Radical Precursor

Among the above examples, phosphorus compounds, germanium, tin, arsenic, antimony, selenium, and tellurium compounds are particularly preferable because they do not generate an odor.

Examples of phosphorus compounds include diphenylphosphine oxide (DPO), di-p-tolylphosphine oxide (TPO), and bis(3,5-dimethylphenyl)phosphine oxide (DPPO).

The amount of the radical precursor added is not particularly limited because an appropriate addition amount varies depending on the rubber type, and the heating temperature, the heating time and the like to be described below, and 0.5 equivalents to 16 equivalents per 1 g of the rubber may be exemplified and 1 equivalent to 8 equivalents is preferable.

### <3> Radical Initiator

The exemplified azo compounds include 2,2′-azobis(isobutyronitrile) (AIBN), 2,2′-azobis(4-methoxy-2,4-dimethylvaleronitrile), 2,2′-azobis(2,4-dimethylvaleronitrile), 1,1′-azobis(cyclohexane-1-carbonitrile), 2,2′-azobis(2-methylbutyronitrile), 1,1′-azobis(cyclohexane-1-carbonitrile), dimethyl 2,2′-azobis(isobutyrate), and 4,4′-azobis(4-cyanovaleric acid).

In addition, examples of peracid compounds include di-tert-butyl peroxide, cumene hydroperoxide, dicumyl peroxide, and benzoyl peroxide (BPO).

The amount of the radical initiator added is not particularly limited because an appropriate addition amount varies depending on the rubber type, and the heating temperature, the heating time and the like to be described below, and 0.5 equivalents to 16 equivalents per 1 g of the rubber may be exemplified and 1 equivalent to 8 equivalents is preferable.

### <4> Heating Conditions

The heating temperature is not particularly limited because an appropriate temperature varies depending on the rubber type, each of the addition amounts, the heating time and the like, and 90° C. to 180° C. may be exemplified.

The heating time is not particularly limited because an appropriate temperature varies depending on the rubber type, each of the addition amounts, the heating temperature and the like, and 1 hour to 24 hours may be exemplified.

It is preferable to add a solvent and heat.

It is preferable to stir during heating.

### <5> Desulfurization Index

When rubber comes into contact with a solvent, it entraps the solvent and swells. This swelling also occurs in rubber before desulfurization, but the swelling rate determined by the following Formula 1 becomes higher as the rubber becomes further desulfurized. This is because the solvent enters where the sulfur bond is cleaved.

swelling rate (%)=(swelled weight−dry weight)/dry weight×100 (Formula 1)

Here, in the present invention, rubber before desulfurization (dry weight 1 g) is immersed in toluene as a solvent at room temperature for 24 hours, and the swelled weight is then measured to determine a swelling rate of rubber before desulfurization. In addition, rubber after desulfurization (dry weight 1 g) is immersed in the same solvent for the same time, and the swelled weight is then measured to determine a swelling rate of rubber after desulfurization. Then, the rate of increase in swelling rate determined by the following Formula 2 is used as a desulfurization index.

rate of increase in swelling rate=swelling rate of rubber after desulfurization/swelling rate of rubber before desulfurization (Formula 2)

However, since ease of swelling differs depending on the rubber type, it is difficult to uniformly evaluate the degree of desulfurization of various rubbers using the rate of increase in swelling rate, and there is a preferable rate of increase for each rubber type.

For example, the rate of increase in swelling rate of EPDM rubber is preferably 1.13 or more (progress of desulfurization is considered to be observed), more preferably 1.30 or more, still more preferably 1.50 or more, and most preferably 2.00 or more.

In addition, the rate of increase in swelling rate of natural rubber is preferably 1.80 or more (progress of desulfurization is considered to be observed), more preferably 2.00 or more, still more preferably 2.50 or more, and most preferably 3.00 or more.

### EXAMPLES

Next, examples of the present invention will be described. Here, materials, conditions, structures, shapes and sizes of examples are only examples, and can be appropriately changed without departing from the spirit and scope of the invention.

### [Experiment 1]

As a desulfurization experiment for sulfur-crosslinked EPDM rubber, Comparative Example 1 and Examples 1 to 7 shown in Table 1 were performed.

TABLE 1

| | | Comparative | | | | | | | |
|---|---|---|---|---|---|---|---|---|---|
| | | Example | Example | | | | | | |
| | | 1 | 1 | 2 | 3 | 4 | 5 | 6 | 7 |
| Sulfur-crosslinked | EPDM | 1 | 1 | 1 | 1 | 1 | 1 | 1 | 1 |
| rubber (g) | | | | | | | | | |
| Solvent (mL) | Xylene | — | 10 | 10 | 10 | 10 | 10 | 10 | 10 |
| Radical precursor (eq) | DPO | — | 0.5 | 1 | 2 | 4 | 8 | 12 | 16 |
| Radical initiator (eq) | AIBN | — | 0.5 | 1 | 2 | 4 | 8 | 12 | 16 |

| | | | | | | | | |
|---|---|---|---|---|---|---|---|---|
| Heating temperature (° C.) | — | 160 | 160 | 160 | 160 | 160 | 160 | 160 |
| Heating time (hr) | — | 5 | 5 | 5 | 5 | 5 | 5 | 5 |
| Stirring rotation speed (rpm) | — | 1000 | 1000 | 1000 | 1000 | 1000 | 1000 | 1000 |
| Number of reactions | — | 1 | 1 | 1 | 1 | 1 | 1 | 1 |
| Swelling rate (%) | 188 | 214 | 230 | 264 | 319 | 384 | 381 | 404 |
| Rate of increase in swelling rate | | 1.138 | 1.223 | 1.404 | 1.697 | 2.043 | 2.027 | 2.149 |
| (vs. Comparative Example 1) | | | | | | | | |

Comparative Example 1 was sulfur-crosslinked EPDM rubber (ethylene content: 53.7 mass, diene content: 9.4 mass %, sulfur component: 0.43 mmol), and was not desulfurized.

In Examples 1 to 7, the same sulfur-crosslinked EPDM rubber as in Comparative Example 1 was reacted using the following methods (1) to (3).

(1) using a personal organic synthesis device PPS-5511 (commercially available from Tokyo Rikakikai Co., Ltd. (EYELA)), 1 g (size: 10 mm×10 mm×2 mm) of sulfur-crosslinked EPDM rubber was put into a reaction container, 10 mL of xylene as a solvent was additionally added, and the mixture was left at room temperature for 1 day.

(2) 0.5 to 16 equivalents (varies for each example) of AIBN as a radical initiator and 0.5 to 16 equivalents (varies for each example) of DPO as a radical precursor were additionally added to the reaction container, and the mixture was heated at 160° C. for 5 hours. During heating, stirring was continued at a stirring rotation speed of 1,000 rpm using a stirring bar of the same device.

(3) the EPDM rubber was taken out from the reaction container, washed with ethanol three times, and then heated and dried at 40° C. The above reaction was performed only once.

There was substantially no odor generated during the reaction in Examples 1 to 7, and there was substantially no odor remaining in the EPDM rubber after the reaction.

After the reaction, according to the method described in the section of “<5> Desulfurization index,” the swelling rate of Comparative Example 1 (before desulfurization) was determined and the swelling rate of Examples 1 to 7 (after desulfurization) was determined. In addition, the rate of increase in swelling rate of Examples 1 to 7 to the swelling rate of Comparative Example 1 was calculated. These results are shown in Table 1.

In Examples 1 to 7, the rates of increase in swelling rate were all 1.13 or more, and desulfurization was observed in the EPDM rubber.

Comparing Examples 1 to 7, it was found that desulfurization progressed when the amount of the radical precursor and the radical initiator added increased. However, it was found that, when the amount added was larger than 8 equivalents, the increase in swelling rate became slower and thus 8 equivalents was sufficient.

The mechanism of the desulfurization reaction in Examples 1 to 7 was inferred as follow. First, a scheme (Chem. 1) is shown.

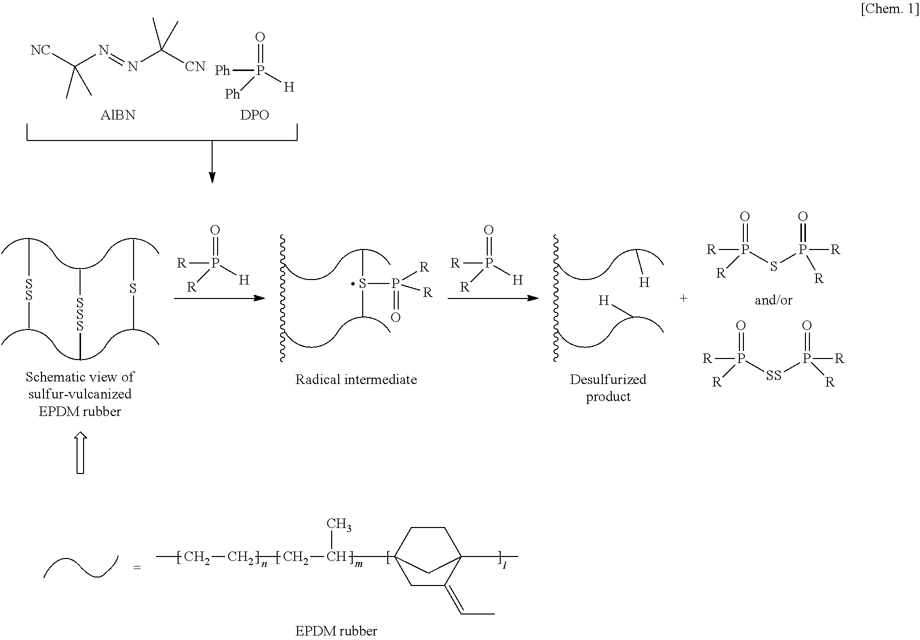

1) two C—N double bonds near the center of AIBN were cleaved by heating and nitrogen gas and 2-cyano-2-propyl radicals were generated.

2) the generated propyl radicals reacted with H of a phosphorus-centered radical precursor, and the radicals were transferred onto phosphorus atoms to generate phosphine oxide radicals.

3) the phosphine oxide radicals reacted with a sulfur bond in the sulfur-crosslinked rubber to generate a radical intermediate.

4) the phosphine oxide radicals generated in 2) further reacted with the radical intermediate in 3) to cleave the sulfur bond.

5) desulfurization of the sulfur-crosslinked rubber progressed while repeating 1)-4).

### [Experiment 2]

Next, as a desulfurization experiment for sulfur-crosslinked EPDM rubber, Examples 8 to 20 shown in Tables 2 and 3 were performed. Comparative Example 1 is also listed in Tables 2 and 3.

TABLE 2

| | | Comparative | | | | | | |
|---|---|---|---|---|---|---|---|---|
| | | Example | Example | | | | | |
| | | 1 | 8 | 9 | 10 | 11 | 12 | 13 |
| Sulfur-crosslinked | EPDM | 1 | 1 | 1 | 1 | 1 | 1 | 1 |
| rubber (g) | | | | | | | | |
| Solvent (mL) | Xylene | — | 20 | 10 | 10 | 10 | 10 | 10 |
| Radical precursor (eq) | DPO | — | 2 | 2 | 2 | 2 | 2 | 2 |
| Radical initiator (eq) | AIBN | — | 2 | 2 | 2 | 2 | 2 | 2 |

| | | | | | | | |
|---|---|---|---|---|---|---|---|
| Heating temperature (° C.) | — | 160 | 110 | 160 | 160 | 160 | 160 |
| Heating time (hr) | — | 5 | 5 | 5 | 5 | 24 | 5 |
| Stirring rotation speed (rpm) | — | 1000 | 900 | 900 | 2000 | 1000 | 1000 |
| Number of reactions | — | 1 | 1 | 1 | 1 | 1 | 2 |
| Swelling rate (%) | 188 | 228 | 228 | 250 | 258 | 305 | 370 |
| Rate of increase in swelling rate | | 1.213 | 1.213 | 1.330 | 1.372 | 1.622 | 1.968 |
| (vs. Comparative Example 1) | | | | | | | |

TABLE 3

| | | Comparative | | | | | | | |
|---|---|---|---|---|---|---|---|---|---|
| | | Example | Example | | | | | | |
| | | 1 | 14 | 15 | 16 | 17 | 18 | 19 | 20 |
| Sulfur-crosslinked | EPDM | 1 | 1 | 1 | 1 | 1 | 1 | 1 | 1 |
| rubber (g) | | | | | | | | | |
| Solvent (mL) | Xylene | — | 10 | 10 | 10 | — | — | — | — |
| | ODCB | — | — | — | — | 10 | — | — | — |
| | Toluene | — | — | — | — | — | 10 | 10 | 10 |
| Radical precursor (eq) | DPO | — | — | — | 4 | 4 | 2 | 2 | 2 |
| | TPO | — | 4 | — | — | — | — | — | — |
| | DPPO | — | — | 4 | — | — | — | — | — |
| Radical initiator (eq) | AIBN | — | 4 | 4 | 4 | 4 | 2 | 2 | 2 |

| | | | | | | | | |
|---|---|---|---|---|---|---|---|---|
| Heating temperature (° C.) | — | 160 | 160 | 160 | 160 | 100 | 110 | 110 |
| Heating time (hr) | — | 5 | 5 | 5 | 5 | 5 | 5 | 5 |
| Stirring rotation speed (rpm) | — | 1000 | 1000 | 1000 | 1000 | 900 | 900 | 2000 |
| Number of reactions | — | 1 | 1 | 2 | 1 | 1 | 1 | 1 |
| Swelling rate (%) | 188 | 294 | 300 | 456 | 424 | 213 | 228 | 233 |
| Rate of increase in swelling rate | | 1.564 | 1.596 | 2.426 | 2.255 | 1.133 | 1.213 | 1.239 |
| (vs. Comparative Example 1) | | | | | | | | |

In Examples 8 to 20, the same sulfur-crosslinked EPDM rubber as in Comparative Example 1 was reacted in basically the same manner as in the methods (1) to (3) of Experiment 1, but the differences from Examples 3 and 4 of Experiment 1 are as follows.

In Example 8, the amount of xylene in the above (1) was 20 mL.

In Example 9, the heating temperature in the above (2) was 110° C., and the stirring rotation speed was 900 rpm.

In Example 10, the stirring rotation speed in the above (2) was 900 rpm.

In Example 11, the stirring rotation speed in the above (2) was 2,000 rpm.

In Example 12, the heating time in the above (2) was 24 hours.

In Example 13, the reaction treatment in the above (1) to (3) was performed twice. Specifically, the EPDM rubber that was heated and dried after the above (3) was completed was put into a reaction container again as in the above (1), 10 mL of xylene was added again, and the mixture was left at room temperature for 1 day. Then, the above (2) and (3) were performed in the same manner as the first time.

In Example 14, the radical precursor in the above (2) was TPO, and the amount of the radical precursor and radical initiator added was 4 equivalents.

In Example 15, the radical precursor in the above (2) was DPPO, and the amount of the radical precursor and radical initiator added was 4 equivalents.

In Example 16, the amount of the radical precursor and radical initiator added in the above (2) was 4 equivalents, and the reaction treatment in the above (1) to (3) was performed twice.

In Example 17, the solvent in the above (1) was o-dichlorobenzene (ODCB), and the amount of the radical precursor and radical initiator added in the above (2) was 4 equivalents.

In Example 18, the solvent in the above (1) was toluene, the heating temperature in the above (2) was 100° C., and the stirring rotation speed was 900 rpm.

In Example 19, the solvent in the above (1) was toluene, the heating temperature in the above (2) was 110° C., and the stirring rotation speed was 900 rpm.

In Example 20, the solvent in the above (1) was toluene, the heating temperature in the above (2) was 110° C., and the stirring rotation speed was 2,000 rpm.

There was substantially no odor generated during the reaction of Examples 8 to 20, and there was substantially no odor remaining in the EPDM rubber after the reaction.

After the reaction, according to the method described in the section of “<5> Desulfurization index,” the swelling rate of Examples 8 to 20 (after desulfurization) was determined. In addition, the rate of increase in swelling rate of Examples 8 to 20 to the swelling rate of Comparative Example 1 was calculated. These results are shown in Tables 2 and 3.

In Examples 8 to 20, the rates of increase in swelling rate were all 1.13 or more, and the progress of desulfurization in the EPDM rubber was reliably observed.

Comparing Examples 3 and 8, it was found that the progress of desulfurization slightly changed when the amount of the solvent added was changed.

Comparing Examples 3 and 9, it was found that desulfurization progressed when the heating temperature was increased.

Comparing Examples 3, 10, and 11, it was found that the progress of desulfurization hardly changed even when the stirring rotation speed was changed to this extent.

Comparing Examples 3 and 12, it was found that desulfurization progressed as the heating time increased.

Comparing Examples 3 and 13, it was found that desulfurization progressed as the number of reaction treatments increased.

Comparing Examples 4, 14, and 15, it was found that desulfurization progressed even when the radical precursor was changed.

Comparing Examples 4 and 16, it was found that desulfurization progressed as the number of reaction treatments increased.

Comparing Examples 4 and 17 and comparing Examples 9 and 18 to 20, it was found that desulfurization progressed even when the solvent was changed.

Thus, looking at Experiment 1 and Experiment 2 together, it was found that, when factors such as the amount of the radical precursor and radical initiator added, the amount of the solvent added, the heating temperature, the heating time, and the number of reactions were adjusted, it was easy to control the progress of desulfurization and a desired swelling rate was obtained. For example, it was inferred that, if the heating time or the number of reactions was increased in Examples 1 and 18, the rate of increase in swelling rate easily became 1.20 or more. In addition, it was inferred that, if the heating time or the number of reactions was increased in Examples 2, 8, 9, 19, and 20, the rate of increase in swelling rate easily became 1.30 or more.

### [Experiment 3]

Next, as a desulfurization experiment for sulfur-crosslinked natural rubber, Comparative Examples 2 and 3 and Example 21 shown in Table 4 below were performed.

TABLE 4

| | | Comparative | | |
|---|---|---|---|---|
| | | Example | | Example |
| | | 2 | 3 | 21 |
| Sulfur-crosslinked | Natural | 1 | 1 | 1 |
| rubber (g) | rubber | | | |
| Solvent (mL) | Xylene | — | 10 | 10 |
| Radical precursor (eq) | DPO | — | — | 4 |
| Radical initiator (eq) | AIBN | — | — | 4 |

| | | | |
|---|---|---|---|
| Heating temperature (° C.) | — | 100 | 100 |
| Heating time (hr) | — | 5 | 5 |
| Stirring rotation speed (rpm) | — | 1000 | 1000 |
| Number of reactions | — | 1 | 1 |
| Swelling rate (%) | 391 | 556 | 1373 |
| Rate of increase in swelling rate | | 1.422 | 3.512 |
| (vs. Comparative Example 2) | | | |

Comparative Example 2 was sulfur-crosslinked natural rubber (sulfur component: 0.99 mmol) and was not desulfurized.

Comparative Example 3 was obtained by simply heating the same sulfur-crosslinked natural rubber as Comparative Example 2 according to the following methods (i) to (iii).

(i) using the personal organic synthesis device, 1 g (size: 10 mm×10 mm×2 mm) of sulfur-crosslinked natural rubber was put into a reaction container, 10 mL of xylene as a solvent was additionally added, and the mixture was left at room temperature for 1 day.

(ii) without adding anything else to the reaction container, the sample was heated at 100° C. for 5 hours. During heating, stirring was continued at a stirring rotation speed of 1,000 rpm using a stirring bar of the same device.

(iii) the natural rubber was taken out from the reaction container, washed with ethanol three times, and then heated and dried at 40° C. The above treatment was performed only once.

Example 21 was obtained by reacting the same sulfur-crosslinked natural rubber as Comparative Example 2 basically in the same manner as in the methods (1) to (3) of Experiment 1, but it had a difference in that the heating temperature in the above (2) in Example 4 of Experiment 1 was 100° C. This is because the natural rubber had low heat resistance due to a carbon-carbon double bond in its main chain.

There was substantially no odor generated during the reaction in Example 21, and there was substantially no odor remaining in the natural rubber after the reaction.

After the heat treatment or after the reaction, according to the method described in the section of “<5> Desulfurization index,” the swelling rate of Comparative Examples 2 and 3 was determined, and the swelling rate of Example 21 (after desulfurization) was determined. In addition, the rate of increase in swelling rate of Example 21 to the swelling rate of Comparative Example 2 was calculated. These results are shown in Table 4.

Although the swelling rate increased in Comparative Example 3 (simple heat treatment), this is thought to have been caused by thermal decomposition occurring during heating at 100° C.×5 h (as described above, because natural rubber had low heat resistance), not by the progress of desulfurization.

It was thought that, in Example 21, the rate of increase in swelling rate was very high, and about 2.5 times that of Comparative Example 3, and thus the progress of desulfurization reaction was significant. Therefore, it was confirmed that the desulfurization method of the present invention could also be applied to natural rubber.

### [Experiment 4]

Next, as a desulfurization experiment for peroxide-crosslinked EPDM rubber, Comparative Examples 4 and 5 shown in Table 5 below were performed.

TABLE 5

Comparative
Example

| | | 4 | 5 |
|---|---|---|---|
| Peroxide-crosslinked | EPDM | 1 | 1 |
| rubber (g) | | | |
| Solvent (mL) | Xylene | — | 10 |
| Radical precursor (eq) | DPO | — | 2 |
| Radical initiator (eq) | AIBN | — | 2 |

| | | |
|---|---|---|
| Heating temperature (° C.) | — | 160 |
| Heating time (hr) | — | 5 |
| Stirring rotation speed (rpm) | — | 1000 |
| Number of reactions | — | 1 |
| Swelling rate (%) | 166 | 171 |
| Rate of increase in swelling rate | | 1.030 |
| (vs. Comparative Example 4) | | |

Comparative Example 4 was peroxide-crosslinked EPDM rubber (ethylene content: 53.7 mass %, diene content: 9.4 mass %, sulfur component: 0 mmol) and was not desulfurized.

In Comparative Example 5, the same peroxide-crosslinked EPDM rubber as Comparative Example 4 was treated and reacted in basically the same manner as in the methods (1) to (3) of Experiment 1.

After the treatment, according to the method described in the section of “<5> Desulfurization index,” the swelling rate of Comparative Examples 4 and 5 was determined. In addition, the rate of increase in swelling rate of Comparative Example 5 to the swelling rate of Comparative Example 4 was calculated. These results are shown in Table 5.

Comparative Example 5 had the same swelling rate as Comparative Example 4. This indicates that the peroxide-crosslinked C—C bond or C—H bond was not cleaved according to the radical reaction in which the radical precursor and radical initiator of the present invention were combined, and also indicates that the main chain of the EPDM rubber was not cleaved.

Considering Experiments 1 to 3 and Experiment 4 together, it was confirmed that, according to the radical reaction in which the radical precursor and radical initiator of the present invention were combined, regardless of the rubber type, the sulfur bond in the sulfur-crosslinked rubber is selectively cleaved, and thus desulfurization progressed, and the main chain of the rubber was not cleaved so that deterioration in physical properties was reduced.

Therefore, the rubbers after desulfurization of Examples 1 to 21 were reusable as high-quality raw rubber.

Here, the present invention is not limited to the examples, and can be embodied by being appropriately changed without departing from the spirit and scope of the invention.

1. A method of desulfurizing sulfur-crosslinked rubber, comprising
adding a radical precursor that generates a radical active species that acts on a sulfur bond in the sulfur-crosslinked rubber and cleaves the sulfur bond and a radical initiator for generating a radical for converting the radical precursor into the radical active species to the sulfur-crosslinked rubber and performing heating.

2. The method of desulfurizing sulfur-crosslinked rubber according to claim 1,
wherein the radical precursor is at least one selected from the group consisting of phosphorus compounds, germanium, tin, arsenic, antimony, selenium, tellurium compounds, silicon compounds, and boron compounds.

3. The method of desulfurizing sulfur-crosslinked rubber according to claim 1,
wherein the radical initiator is at least one selected from the group consisting of azo compounds and peracid compounds.

4. The method of desulfurizing sulfur-crosslinked rubber according to claim 2,
wherein the radical initiator is at least one selected from the group consisting of azo compounds and peracid compounds.
